(19) United States
(12) Patent Application Publication
(10) Pub. No.: US 2006/0025017 A1
(43) Pub. Date: Feb. 2, 2006

(54) Releasable snap connection

(76) Inventors: Gunter Sikora, Steyr (AT); Gerhard Sikora, Steyr (AT)

Correspondence Address: MARK D. LORUSSO;LORUSSO & LOUD, SUITE 312, 15 RYE STREET, PORTSMOUTH, NH, 03801, US

(21) Appl. No.: 11/198,125

(22) Filed: Aug. 5, 2005

Related U.S. Application Data
(63) Continuation of application No. PCT/AT04/00038, filed on Feb. 5, 2004.

(30) Foreign Application Priority Data
Feb. 5, 2003 (AT) A 178/2003

(51) Int. Cl. H01R 13/66

(52) U.S. Cl. 439/620

(57) ABSTRACT

The invention relates to a releasable snap-in connection between a resilient element and another element, which comprises a snap-in element having a shaft and a snap-in tip, and a snap-in seat. The invention is characterized in that the snap-in element engages at least partially in the snap-in seat and in that the snap-in element comprises a cylinder mounted to be slideable along its shaft for releasing the snap-in connection.

The invention relates to a releasable snap connection between an elastically resilient part and a preferably rigid part, said snap connection comprising both a locking element, which has a shaft and a locking tip, and a locking receptacle, the locking element engaging at least partially in the locking receptacle.

A device for fastening an appliance to a wall is known from DE 92 17 185 U1 in which a mounting pin engages in an elastically resilient receptacle of an object to be mounted. The mounting pin shown has a portion of reduced diameter, at which resilient limbs of the receptacle engage. In the case of the device shown, the snap connection is released by withdrawing the pin from the receptacle against the clamping force of the resilient limbs. It has been found that a disadvantage of this known snap device is that a vertical use of the snap connection, as is desirable, for example, for mounting objects on the ceiling, is not convenient in practice, since the snap connection would normally be released, against the clamping force of the resilient limbs, by the intrinsic weight of the object mounted on the ceiling.

Additionally known, from U.S. Pat. No. 5,327,619, is a snap connection between a resilient locking element and a locking receptacle, in which the locking receptacle has means for releasing the snap connection, the means for releasing the snap connection being of such design that the resilient locking element and the locking receptacle can be disengaged, in order to release such a snap connection, both the locking element and the means, arranged in the locking receptacle, for releasing the snap connection must thus be accessible and capable of being operated; this, in addition to being awkward to manipulate, almost precludes vertical use of the snap connection.

Proceeding from this prior art, the object of the invention is to create a new type of snap connection which can be released in a simple manner whilst avoiding the previously described disadvantages.

This is achieved, according to the invention, in that, for the purpose of releasing the snap connection, the locking element has a sleeve so mounted that it is movable along its shaft. This means that, for the purpose of releasing the snap connection, the movable sleeve can be brought into a position which releases the resilient part in relation to the rigid part, and remains in this position until the locking element and the locking receptacle are disengaged.

Similarly, in the case of another embodiment of the invention, for the purpose of releasing the snap connection, the movable sleeve can be brought into a position which releases the first resilient part in relation to the second rigid part, and remains in this position until the locking element and the locking receptacle are disengaged, if both parts constituting the snap connection are of elastically resilient construction.

In the case of the snap connection according to the invention, therefore, the locking element, which has a shaft and a locking tip, is inserted into the locking receptacle until the snap connection is made. To release this snap connection, it is subsequently necessary only for the locking element to be pressed further into the locking receptacle, in order thereby to disengage the locking tip from the locking receptacle. The fact that the sleeve is movable ensures that the sleeve remains in its release position, i.e., the position in which the locking tip is disengaged from the locking receptacle, until the locking element and the locking receptacle was disengaged, or released.

According to a variant of the invention it is provided that the one resilient: part of the snap connection is constituted by the locking receptacle, while the other, preferably rigid, part of the snap connection is constituted by the locking element, it being the case, according to a preferred version, that the locking receptacle has at least one resilient limb, which is shaped to encompass the locking tip of the locking element in a preferably positive manner.

Since the resilient part of the snap connection is constituted by the locking receptacle, it is possible for the locking element, particularly the locking tip, to be realized rigidly, particularly in the form of a bolt. Damage to the locking element, which may be produced from metal, wood, plastic or the like, can thereby be prevented to a very large extent. If the resilient limb is shaped to encompass the locking tip in a positive manner, this, particularly in the case of a vertical use of the snap connection, prevents the locking element, or an object to be held that is connected to the locking element, from unintentionally releasing the snap connection, against the clamping force of the resilient limbs, due to its weight.

In order to ensure that, when the locking element is pressed further into the locking receptacle, the sleeve is brought into a position which releases the resilient part in relation to the rigid part and does not slip back along the shaft, it is provided, according to another embodiment of the invention, that the shaft of the locking element has a preferably annular, flange-type enlargement, the sleeve being so arranged on the shaft that it is movable between this flange-type enlargement and the locking tip. It has been found to be particularly advantageous in this case if the locking receptacle has at least two resilient, preferably substantially L-shaped limbs whose free ends are shaped to engage between the locking tip and the flange-type enlargement.

According to another embodiment of the invention it is provided that the locking receptacle has at least one springy element which is convex in relation to the locking element and which, when the connection has been made, engages at least with the shaft of the locking element, providing that, according to a preferred embodiment, the locking receptacle has a plurality of convex, preferably tongue-shaped springy elements, which constitute a funnel. This particularly inexpensive design of the locking receptacle, which is also particularly stable, then has a further advantage if the funnel is arranged in, or is part of, a preferably cylindrical housing. In the case of a locking receptacle, realized thus, the free ends of the tongue-shaped spring elements are arranged within the housing and, in particular, axially spaced apart from the receiving aperture of the locking receptacle, so that damage to the free ends of the tongue-shaped spring elements can be almost totally precluded.

If the sleeve is conically tapered on its side which faces the locking tip and/or the free end(s) of the limb(s) of the locking receptacle is (are) bevelled, the sleeve can be brought more easily into engagement with the resilient part of the locking receptacle. For the same reason, it is advantageous if the locking tip is conically tapered, rounded or hemispherical in form.

A particularly simple embodiment of the invention provides that the locking receptacle is realized in the form of a shaped tube, preferably having a rectangular cross-sectional area, and has at least one longitudinally extending passage aperture for the locking element(s), the wall of the tube having, on at least one side of the passage aperture, a plurality of gaps which extend substantially perpendicularly relative to the passage aperture and as far as the passage aperture. Thus, if the snap connection is used for attaching, for example, clothes-hangers or hooks or for mounting requisites such as tools or household appliances, only the shaped tube serving as a locking receptacle need to be attached to the wall, ceiling or elsewhere so that, subsequently, the objects to be held, each of which per se normally has a locking element, can be attached in that they are simply pressed into the passage aperture of the shaped tube.

If the locking receptacle is mounted in a housing having a passage aperture for the locking element, and the resilient limbs bear on the housing by means of their ends which encompass the locking tip of the locking element, this can prevent the locking elements from becoming detached by themselves from the locking receptacle—even if they are connected to a relatively heavy object, such as a clothes-hanger holding an item of clothing. It has been found to be particularly advantageous in this case if the housing is arranged so as to be movable in a shaped tube having a longitudinally extending passage aperture, enabling the objects held by means of the snap connection to be freely movable, by means of the housing, in the shaped tube. Such a design has proved to be useful particularly when the invention is used in wardrobe racks, and for mounting drapes or curtains.

According to a further variant of the invention it is provided that the one, resilient, part of the snap connection is constituted by the locking element, while the other, preferably rigid, part of the snap connection is constituted by the locking receptacle. In the case of this variant, in which the locking element advantageously has at least two locking segments which are of radially resilient construction, it is possible to dispense entirely with a special design of the locking receptacle. According to a preferred embodiment of the invention, it suffices if the locking receptacle is constituted by a bore in the preferably rigid part of the snap connection, for example, in a wooden, metal or plastic panel or the like.

An alternative embodiment provides that the locking receptacle is realized as a shaped tube and has at least one bore and/or at least one longitudinally extending passage aperture for a resilient locking element, the locking elements thereby being rendered movable in the locking receptacle.

In order to ensure the radial mobility of the locking segments, the radial mobility of which must be effected both inwards, i.e. towards the longitudinal centre maxis of the locking element, and outwards—after the locking tip has passed through the locking receptacle-, another embodiment of the invention provides that at least one locking segment comprises a portion of the locking tip and a portion of the shaft of the casing. A simple construction is obtained if the sleeve also has at least two casing segments which are of radially resilient construction, the snap connection being able to be released particularly easily if the locking segments of the locking element and the casing segments of the sleeve are designed to engage with one another in a preferably positive manner.

Secure engagement of the locking element with the locking receptacle can be achieved if the free ends of the locking segments of the locking element and/or the free ends of the casing segments of the sleeve are of a hook-shaped configuration. As in a first step, the hook-shaped locking tip is brought into engagement with the locking receptacle. To release the snap connection, the sleeve, or at least the hook-shaped casing segments of the sleeve, are then, in a further step, brought into engagement with the locking receptacle, as a result of which the locking segments of the locking elements are simultaneously disengaged from the locking receptacle. Upon withdrawal of the locking element from the locking receptacle, the exterior surface segments of the sleeve and the hook-shaped locking segments of the locking element then engage positively with one another, thereby preventing the locking tip from re-engaging with the locking receptacle.

Alternatively, it would also be conceivable for the outer circumferential surface of the sleeve to be shaped for positive engagement with the locking receptacle so that, to release the snap connection, it is only necessary for a small portion of the sleeve, which in this case does not necessarily need to have resilient casing segments, to be inserted into the locking receptacle.

A preferred embodiment of the invention provides that the one resilient part is constituted by the locking element and the other resilient part is constituted by the locking receptacle. In the case of such a design of the snap connection, the spring travel that has to be managed upon both making and releasing the snap connection is divided between the locking element and the locking receptacle. It is thereby possible, on the one hand, to construct the snap connection overall as a small-dimensioned module and, on the other hand, snapping-in and releasing the snap connection is effected more smoothly than if one of the two parts constituting the snap connection is of rigid construction.

There is also to be disclosed a holding device comprising a snap connection having at least one locking element and one locking receptacle. The new type of holding device is characterized in that the locking element is mounted movably—preferably traversely relative to the direction of insertion E into the locking receptacle. In the case of such a design of the holding device, it is thus only necessary for the locking element to be inserted into the locking receptacle, which can be realized as, for example, a longitudinal hole, and it can then be moved transversely relative to the direction of insertion, as is desirable, for example, in the case of wardrobe racks or in the fitting of drapes or curtains.

A smooth-running and constructionally simple version provides that, when the snap connection has been made, the locking receptacle, together with the locking element, is movable—preferably transversely relative to the direction of insertion E of the locking element-, for example, on a cable or on a guide rod. It would also be conceivable, however, for the locking receptacle to be provided with rollers or the like, if the locking receptacle is arranged in a guide.

A further version which has proved particularly successful in practice provides that the locking receptacle is arranged in a housing, and the housing is arranged on the holding device so as to be movable in a guided manner, preferably in a hollow profile or on a profile bar, a particularly inexpensive solution then being achieved if the locking receptacle is guided on a preferably flexible profile rail. It is thereby possible for a plurality of locking receptacles to be arranged in any alignment, for example in a sinuous line, on a holding device which may be realized, for example, as a veneered pressboard panel, in that there is milled into the holding device a groove which serves to receive a flexible profile rail, there being realized in the housings of the locking receptacles recesses which correspond with the profile of the flexible profile rail, so that the locking receptacles arranged in the housings can be arranged on the flexible profile rail in a simple manner, for example by clipping-on. If the recesses in the housings are of somewhat greater dimensions than the profile of the flexible profile rail, it can thereby be ensured that the housings arranged on the flexible rail can be moved.

Further advantages and details of the snap connection according to the invention are explained more fully in the following with reference to the figures represented in the drawing.

There are shown in:

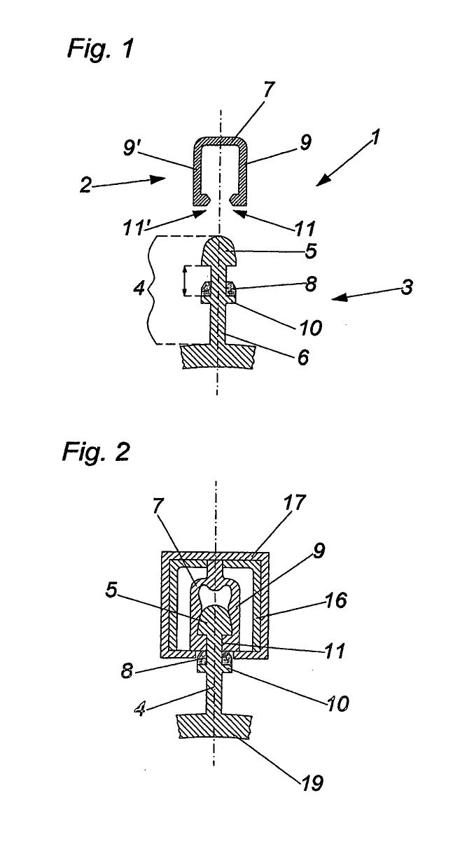

FIG. 1 a released snap connection, with a resiliently realized locking receptacle and a rigid locking element,

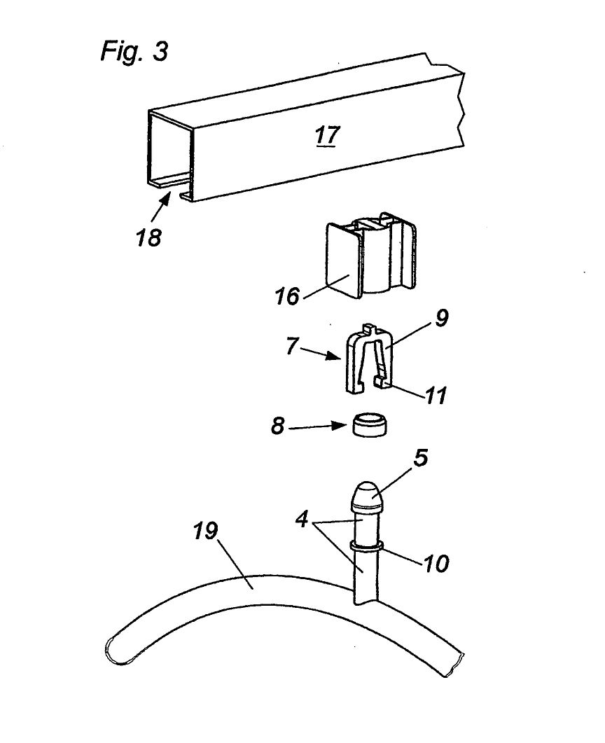

FIG. 2 a cross-section through a shaped tube in which there is arranged a housing, wherein arranged in the housing is a resilient locking receptacle which positively encompasses a rigid locking element,

FIG. 3 an exploded view of the locking connection shown in FIG. 2,

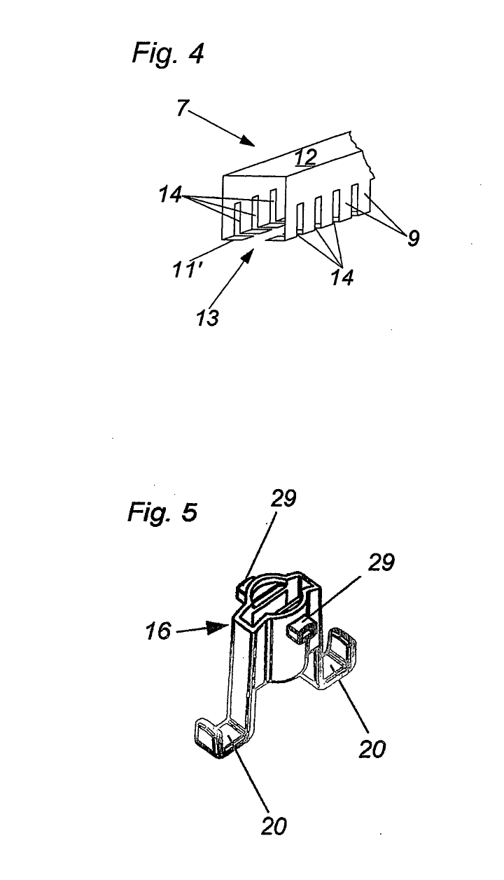

FIG. 4 a locking receptacle in the form of a shaped tubes,

FIG. 5 a housing for receiving a locking receptacle,

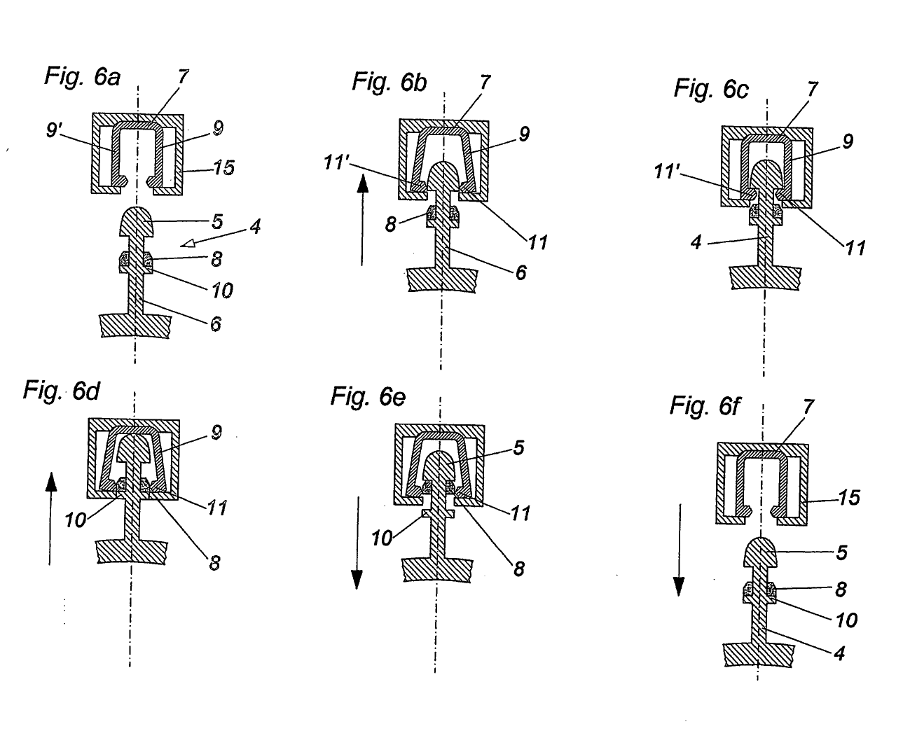

FIGS. 6a to 6f the individual steps for making and releasing a snap connection between a resiliently realized locking receptacle, which is arranged in a housing, and a rigid locking element,

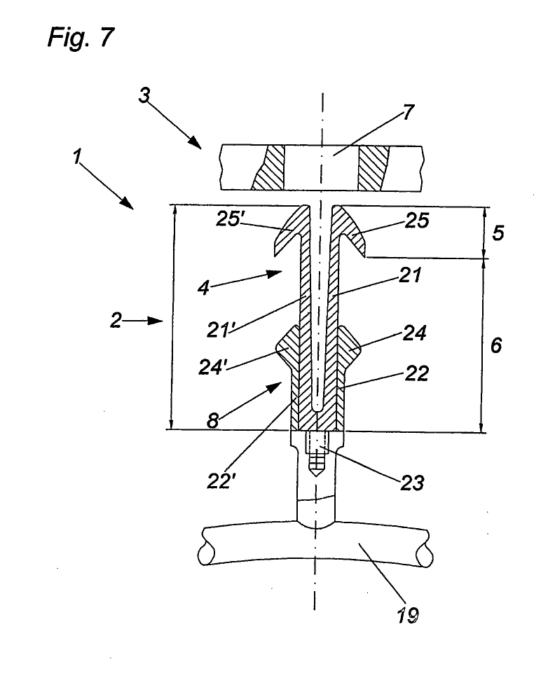

FIG. 7 a further variant of the invention, with a rigid locking receptacle in a resiliently realized locking element,

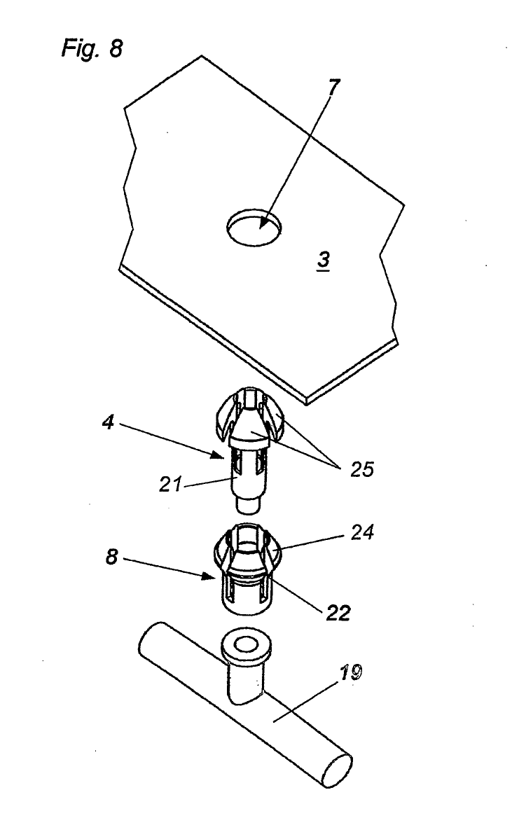

FIG. 8 an exploded drawing of the invention according to FIG. 7,

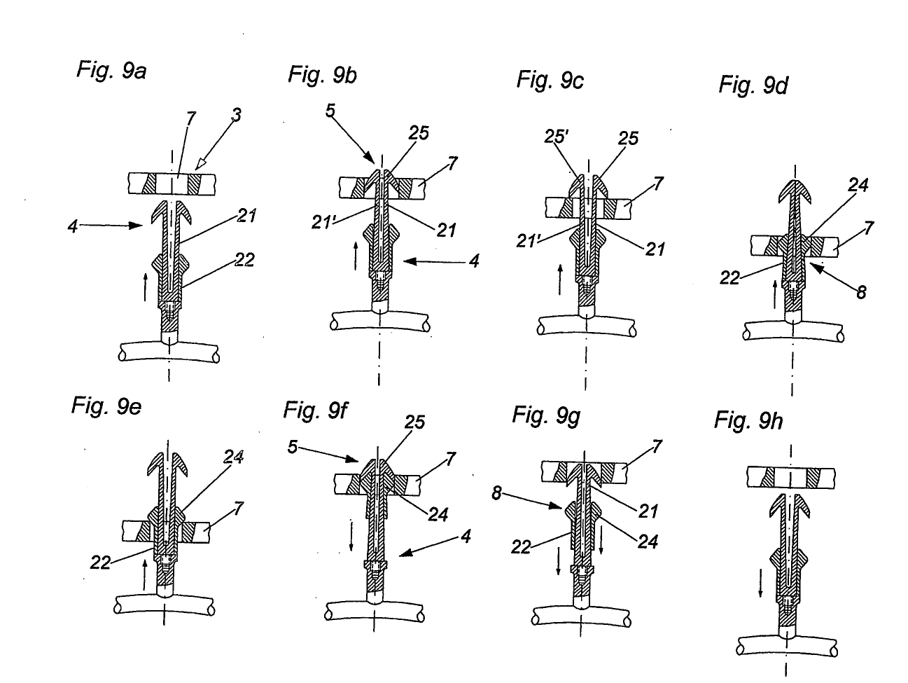

FIGS. 9a to 9h the steps for making and releasing the snap connection, according to the invention, shown in FIG. 7,

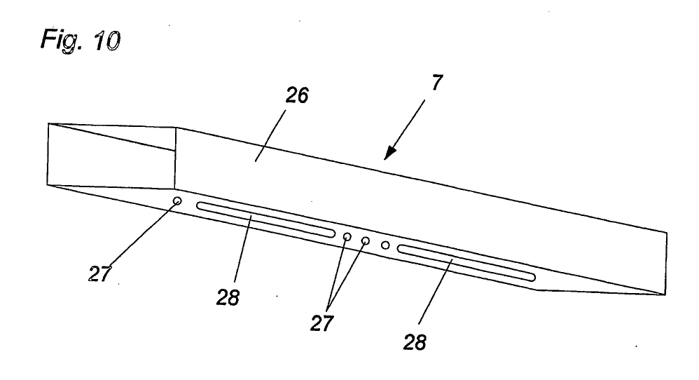

FIG. 10 an embodiment of a rigid locking receptacle realized as a shaped tube,

FIGS. 1a and 1b perspective views of another embodiment of a locking receptacle arranged in a housing,

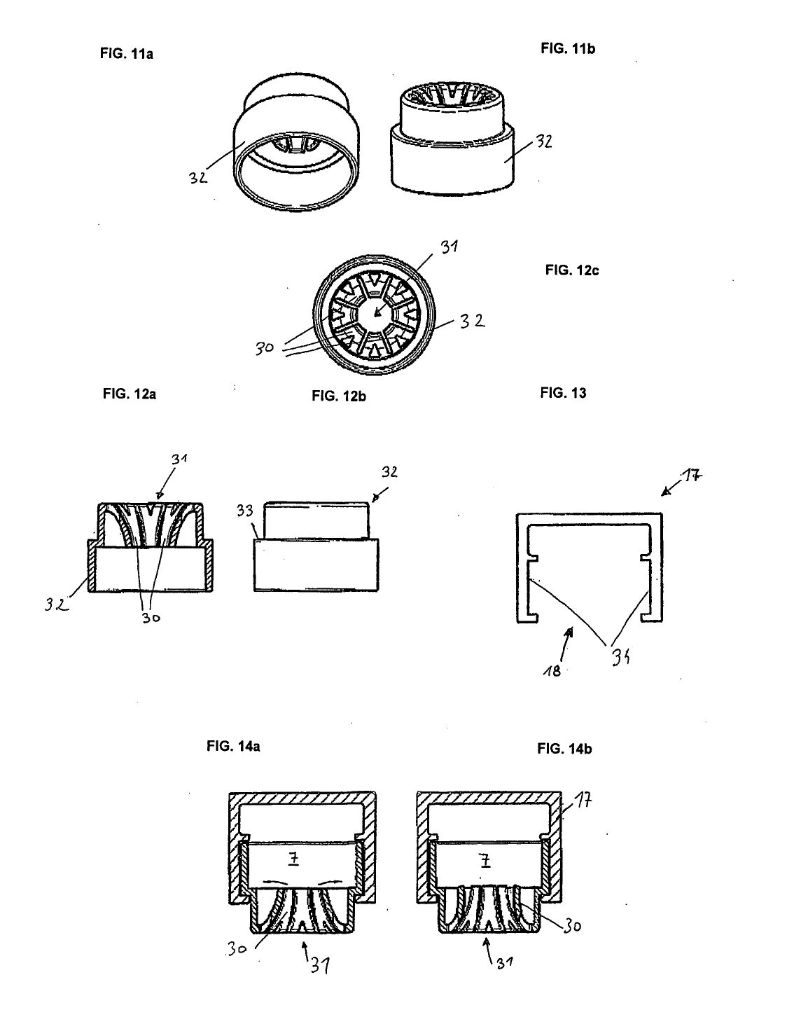

FIGS. 2a to 12c a cross-section, a side view and a top view of the embodiment represented in FIG. 11,

FIG. 13 a cross-section through a shaped tube for receiving the locking receptacle represented in FIG. 11,

FIGS. 14a and 14b a locking receptacle, in the unloaded and loaded state, arranged in a shaped tube.

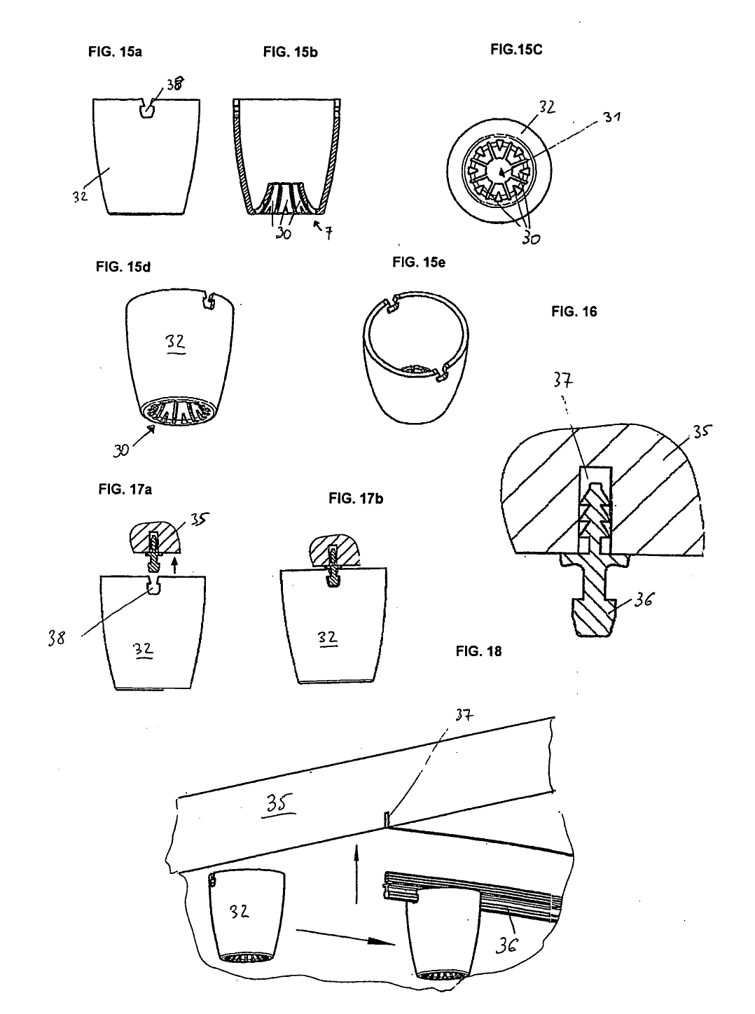

FIGS. 15a to 15e a side view, a cross-section, a top view and perspective views of another embodiment of a locking receptacle arranged in a housing,

FIG. 16 a profile rail arranged in a holding device,

FIGS. 17a and 17b the arrangement of the housing represented in FIG. 15 on the profile rail represented in FIG. 16,

FIG. 18 the principle of arrangement of a first embodiment of a holding device according to the invention,

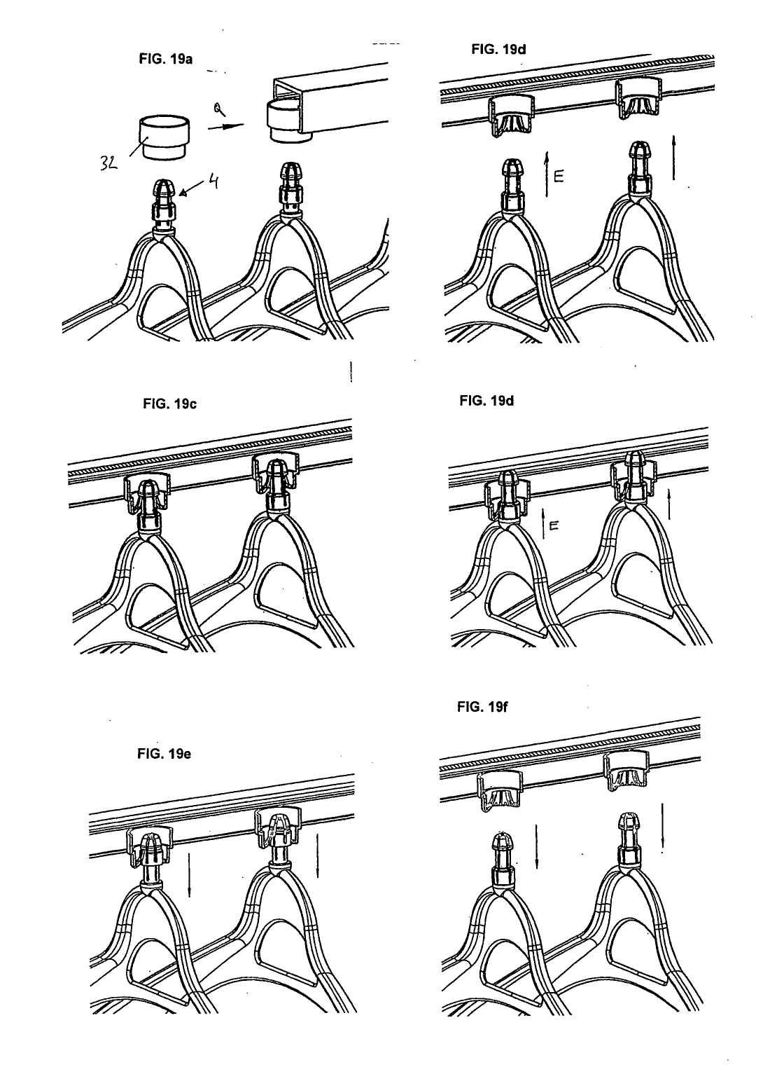

FIGS. 19a to 19f the steps for making and releasing a snap connection in the case of a first holding device according to the invention,

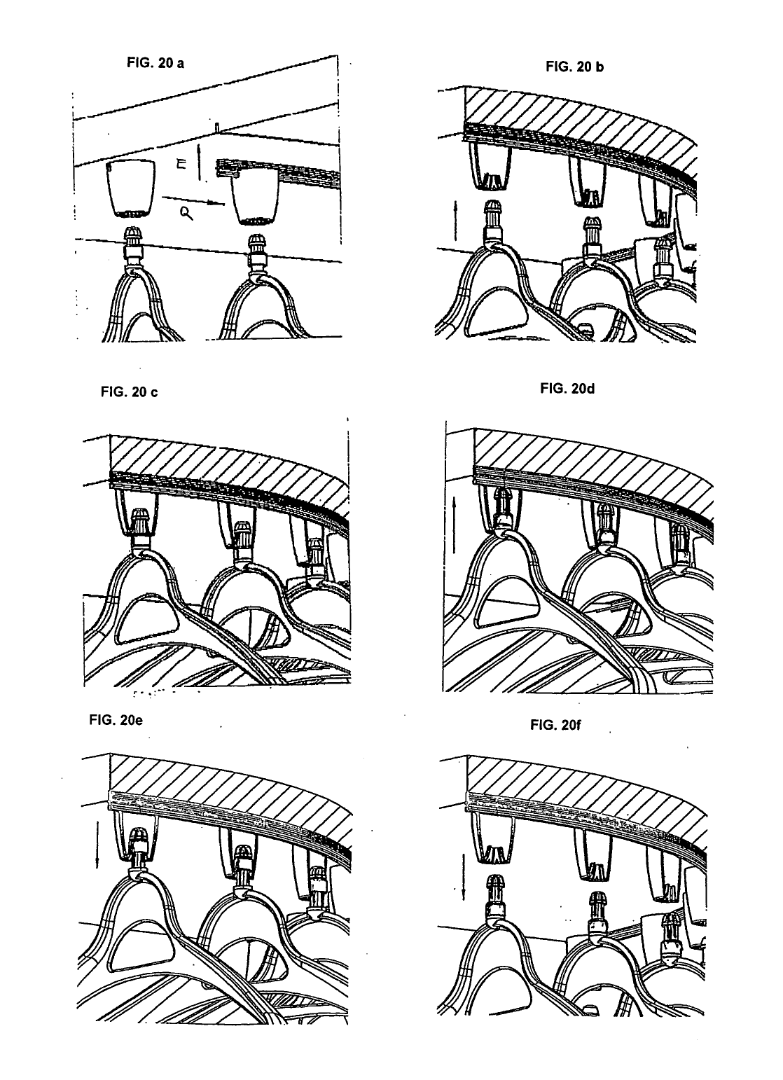

FIGS. 20a to 20b the steps for making and releasing the snap connection in the case of a second embodiment of the holding device according to the invention,

FIG. 21 another embodiment of a locking element,

FIG. 22 a shaped tube with housings movably arranged therein, and

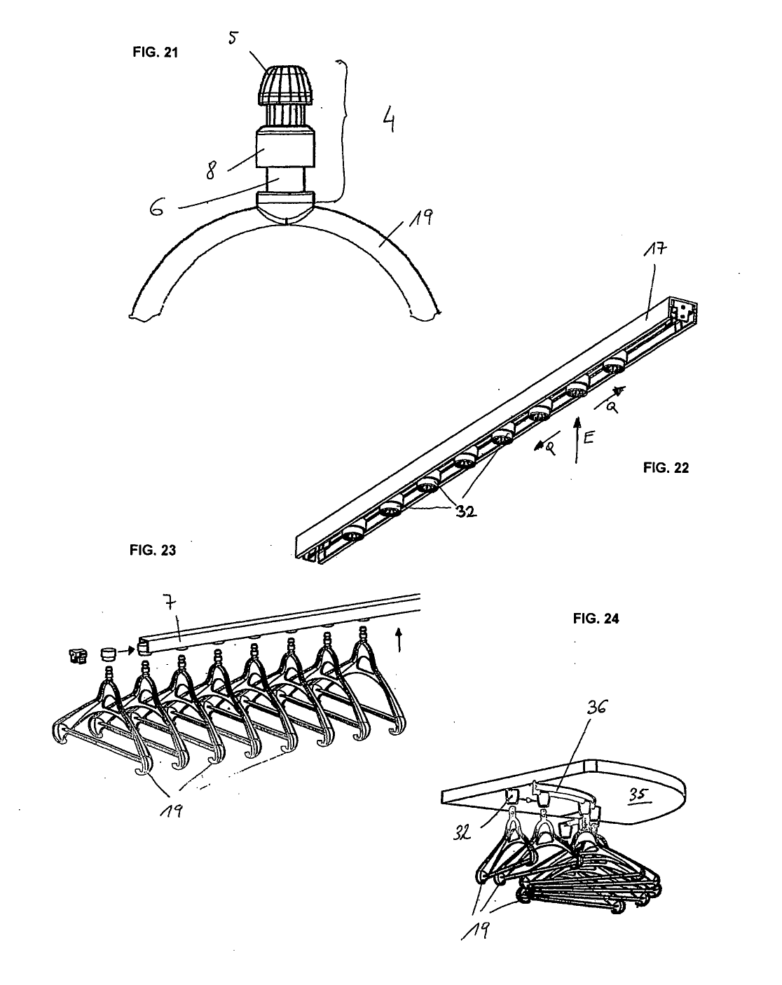

FIGS. 23 and 24 perspective views of two different embodiments of the holding device according to the invention.

In the case of the snap connection 1 shown in FIG. 1, the resilient part 2 is constituted by the locking receptacle 7. The locking receptacle 7, which may be produced from, for example, metal or plastic, is realized as a U-shaped hoop having two resilient limbs 9, 9′. On their naturally facing inner sides, the free ends 11, 11′ of the resilient limbs 9, 9′ have two lobes, at an angle to one another, and are shaped to positively encompass the locking tip 5 of the locking element 4. In the case of the embodiment shown, the locking element 4 constitutes the substantially rigid part 3 of the snap connection 1. Adjoining the locking tip 5, the locking element 4 has a shaft 6, on which a sleeve 8 is movably mounted. Additionally arranged on the shaft 6 is a flange-type enlargement 10, which serves as a stop for the sleeve 8. On its side which faces the locking tip 5, the sleeve 8 is conically tapered so that, when the locking element 4 is pressed into the locking receptacle 7, the free ends 11, 11′ of the resilient limbs 9, 9′ slide more easily on to the sleeve 8. For the same reason, the locking tip 5 is hemispherical in form.

FIG. 2, in which identical parts have identical designations, shows an upright snap connection, the locking receptacle 7 being arranged in a housing 16. The housing 16, for its part, is in turn movably mounted in a shaped tube 17, the resilient limbs 9, 9′ of the locking receptacle bearing on the shaped tube 17. The locking element 4, which is connected, for example, to a clothes-hanger 19, is thereby prevented from being unintentionally released from the locking receptacle 7. Such release is also prevented in that the resilient limbs 9, 9′ are shaped to positively encompass the locking tip 5, the free ends 11, 11′ of the resilient limbs 9, 9′ engaging with the shaft 6 of the locking element 4 between the sleeve 8 and the locking tip 5, and encompassing the locking tip 5.

FIG. 3 shows an exploded drawing of the embodiment represented in FIG. 2, wherein it is to be noted that the sleeve 8 is arranged between the locking tip 5 and the flange-type enlargement 10 on the shaft 6 of the locking element 4. The arrangement of the locking receptacle 7 in the housing 16, which is movably mounted in the shaped tube 17, enables the clothes-hanger 19 connected to the locking element 4 to be moved longitudinally in the shaped tube 17.

Another embodiment, in which the locking receptacle 7 is constituted by a shaped tube 12, is shown in FIG. 4. In the case of this embodiment, the shaped tube 12 has a longitudinally arranged passage aperture 13. One or more locking elements can thus be inserted, through this passage aperture 13, into the locking receptacle 7, resilient limbs 9 being realized by gaps 14 arranged in the side wall of the shaped tube 12. Thus, in contrast to the embodiment represented in FIG. 3, in which it is necessary to check, before the insertion of a locking element 4 into the passage aperture 18, where there is a housing 16 with a locking receptacle 7, the locking element 4, on which there are arranged, for example, a clothes-hanger or requisites such as tools, household appliances or the like, can be inserted at any point into the locking receptacle 7 realized as a shaped tube 12. The gaps not only effect the realization of resilient limbs 9 in the side walls of the shaped tube 12 but, at the same time, they also prevent a locking element 4 already present in the locking receptacle 7 from being disengaged from same by the spreading of the side walls when a locking element 4 is inserted into the shaped tube 12,

FIG. 5 shows another embodiment of a housing 16 for receiving a locking receptacle 7, said housing having auxiliary hooks 20, as well as guide pegs 29, which enable the housing 16 to glide reliably in the shaped tube 17.

FIGS. 6a to 6f show the individual steps for making and releasing a snap connection according to the invention. In FIG. 6a, the locking receptacle is arranged in a housing 15, the resilient limbs 9, 9′ bearing on the housing 15. The locking element 4 is pressed into this locking receptacle 7 in the direction of the arrow, as a result of which, as shown in FIG. 6b, the two resilient limbs are spread apart by the locking tip. At this point in time, the sleeve 8 can still move freely, and lies on the flange-type enlargement 10 of the shaft 6. In FIG. 6c, the snap connection has been made, the free ends 11, 11′ of the resilient limbs having encompassed the locking tip 5, as a result of which, together with the fact that the resilient limbs 9, 9′ bear on the housing 15, a release of the locking element 4 from the locking receptacle 7 can be reliably prevented.

To release the snap connection, the locking element 4 is pressed further into the receptacle 7, as shown in FIG. 6d, as a result of which the resilient limbs 9 are spread apart by the sleeve 8 and engage with the circumferential surface of the sleeve 8. Upon withdrawal of the locking element 4 from the locking receptacle 7 (FIG. 6e), the sleeve 8 continues to constitute the stop for the resilient limbs 9. Since the sleeve 8 is movably mounted on the shaft 6 of the locking element 4, the locking element 4 can be drawn back until the sleeve 8 strikes against the locking tip 5, thereby preventing the free ends 11 of the resilient limbs of the locking tip 5 from being able to engage in an encompassing manner with the shaft 6 of the locking element 4. Upon further withdrawal of the locking element 4, the free ends of the resilient limb 9 first glide over the circumferential surface of the sleeve 8 and, subsequently, over the locking tip 5 until, as shown in FIG. 6f, the snap connection has again been released.

In the case of a further variant, shown in FIG. 7, of the snap connection 1 according to the invention, the rigid part 3 is constituted by the locking receptacle 7, while the resilient part 2 is constituted by the locking element 4. The locking element 4 has a plurality of locking segments 21, 21′, each of which comprises a portion of the locking tip 5 and a portion of the shaft 6 of the locking element 4. In this case, the free ends 25, 25′ of the locking segments 21, 21′ are realized in the form of hooks. Movably mounted on the shaft of the locking element 4 is a sleeve 8, which has casing segments 22, 22′ whose free ends 24, 24′ are likewise realized in the form of hooks, the outsides of the free ends 24, 24′ having lobes at an angle to one another. On its side facing away from the locking receptacle 7, the locking element 4 is connected, by means of a threaded bolt 23, to a clothes-hanger 19, instead of the clothes-hanger 19, it would also be possible to connect requisites such as tools or household articles to the locking element 4.

FIG. 8 shows an exploded view of the version of the invention shown in FIG. 7, from which it can be seen that the locking receptacle 7 is constituted by a bore in the rigid part 3 of the snap connection 1. This rigid part can consist of, for example, a wooden, metal or plastic panel or the like, as a result of which, in contrast to the prior art known hitherto, an article connected to the locking element according to the invention can be attached in an extremely simple manner to almost any aperture.

An alternative version of the locking receptacle 7 according to the invention is represented in FIG. 10. In this case, the locking receptacle 7 is constituted by a shaped tube 26, which has a plurality of bores 27 and/or longitudinally extending passage apertures 28 for locking elements.

FIGS. 9a to 9h show, progressively, the procedure for making and releasing the snap connection according to the invention. Starting from FIG. 9a, in which the locking receptacle 7 and the locking element 4 are disengaged, the locking element 4 is pressed into the locking receptacle 7 in the direction of the arrow. Upon entry of the locking tip 5 into the locking receptacle 7 (FIG. 9b), the radially movable locking segments 21, 21′ of the locking element 4 are pressed together, i.e., towards the longitudinal axis of the locking element 4, until—as shown in FIG. 9c—the hook-shaped free ends 25, 25′ of the locking element 4 have passed fully through the locking receptacle 7 and, as a result of the radial outward movement of the locking segments 21, 21′, engage with the locking receptacle 7.

To release the snap connection (FIG. 9d), the locking element is pressed further into the locking receptacle 7, in the direction of the arrow, until the free ends 24 of the casing segments 22 of the sleeve 8 have likewise passed through the locking receptacle 7 (FIG. 9e). The snap connection is released (FIG. 9f) by withdrawing the locking element 4 from the locking receptacle 7 in the direction of the arrow. In this case, the sleeve 8, owing to the clamping action of the free ends 24 of the resilient casing segments 22, moves towards the locking tip 5 until the hook-shaped free ends 25, 25′ of the locking segments 21, 21′ of the locking element 4 engage positively with the free ends 24 of the casing segments 22 of the sleeve 8, as a result of which, as shown in FIGS. 9f and 9g, the locking element 4 can be withdrawn from the locking receptacle 7 without the hook-shaped free ends 25, 25′ of the locking element 4 becoming hooked on, or engaging with, the locking receptacle 7.

Furthermore, at the point in time represented in FIG. 9g, the clamping action between the sleeve 8 and the locking segments 21 is prevented by the radial outward movement of the casing segments 22, so that the sleeve 8 glides back along the shaft, of the locking element 4, enabling the initial position shown in FIG. 9a to be re-attained.

As shown by FIGS. 11 and 12, in the case of this embodiment the locking receptacle 7 has a plurality of tongue-shaped springy elements 30, which constitute a convex receiving funnel 31 for the locking element (not shown). In particular, FIG. 12a shows that the free ends of the tongue-shaped springy elements 30 are arranged within the housing 32 and, in particular, axially spaced apart from the receiving aperture of the funnel 31. These free ends of the springy tongues are thereby particularly well protected against damage. The housing 32 in which the locking receptacle 7 is arranged has on its circumference a flange-type enlargement 33, which corresponds with the guide groove 34: provided on the inside of the shaped tube 17, so that, on the one hand, the housing 32 cannot slip downwards out of the shaped tube while, on the other hand, it is so mounted in the shaped tube that it can move transversely, in a smooth-running manner, relative to the direction of insertion E of the locking element.

FIG. 14a shows the arrangement of a housing 32 in a shaped tube 17, it being evident that the flange-type enlargement 33 bears on the lower web of the guide groove 34. The arrows indicate the direction in which the convex, tongue-shaped springy elements of the funnel 31 are moved when a locking element (not shown) is inserted into the locking receptacle 7, wherein FIG. 14b shows the position of the springy tongues when a locking element, not shown, has been inserted into the locking receptacle.

A further possible arrangement of a locking receptacle in a housing is represented in FIGS. 15a to 15e. Although the represented locking receptacle 7 has tongue-shaped, convexly bent springy elements 30, it is of course also possible to dispose within the housing 32 locking receptacles having, for example, two L-shaped resilient limbs. Rather, what is of importance in the case of this embodiment is that the hollow-cylinder type housing 32 has recesses 38 which enable the housing 32 to be mounted on a profile bar.

An example of such a profile bar, which is realized as a flexible profile rail 36 and is arranged in a guide groove 37 of a holding device 35, is represented in FIG. 16. FIGS. 17a and 17b show the individual steps for mounting the housing 32 on the profile rail 36. These figures show that, by means of its recesses 38, the housing 32 can be easily mounted on the flexible profile rail, in that it is pressed on or snapped on. As previously mentioned, it is advantageous if the recesses 38 that correspond with the profile rail 36 are of somewhat greater dimensions than the cross-sectional area of the profile rail 36, so that the housing 32 can be moved in a smooth-running manner along the flexible profile rail.

FIG. 18 shows that the mounting of such a preferably flexible profile rail 36 on a holding device is particularly simple. In the case of the embodiment shown, the holding device, for example the base of a shelf of a wardrobe, has a guide groove 37. The preferably flexible profile rail 36 is then pressed into this guide groove 37, in the direction of the arrow. Once the profile rail 36 has been mounted, the housings 32 can be mounted on the profile rail 36 in that they are either clipped on or threaded on, in order that they can subsequently be moved transversely relative to the direction of insertion of the locking element, in the arrow direction Q. Obviously, it would also be possible for the profile rail 36 to be fastened in a different manner to the holding device 35, for example by means of screws or adhesive.

FIGS. 19a to 19f show the steps for making and releasing a first embodiment of a snap connection according to the invention. In this case, as shown by FIG. 19a, at plurality of housings 32 are inserted into a shaped tube 17. The housings 32 are so mounted in the shaped tube 17 that they can be moved transversely relative to the direction of insertion of the locking elements 4, in the direction Q. The locking elements 4 are then pressed into the individual housings, or locking receptacles, in the direction of insertion E, in order to make the snap connection, as represented in FIG. 19c. To release the snap connection, the locking element is pressed further in the direction of insertion E (FIG. 19d), this being to such extent that the springy elements of the locking receptacle bear on the sleeve 8, so that the locking element can be easily withdrawn, since—as shown in FIG. 19e—the springy elements bear on the sleeve and the sleeve is movably mounted on the shaft 6 of the locking element.

The same procedure also applies to the embodiment shown in FIGS. 20a to 20f, for which reason the individual steps are not explained over again. In contrast to the example shown in FIG. 19, however, in the case of the example represented in FIG. 20 the housings 32, with the locking receptacles 7, are arranged on a profile bar 36, in particular on a flexible profile rail. Such a flexible profile rail offers, in addition to simple mounting of the profile rail by pressing into a guide groove 37, the further advantage that such a flexible profile rail 36 can be installed around curves, so that the new type of holding device presents scarcely any further limits to the creative freedoms of furniture designers. The fact that the housing can likewise be attached to the flexible profile rail 36 by clipping on offers not only visual advantages, but the housings can also be easily replaced if damaged.

FIG. 21 shows an embodiment of a locking element having a conically tapered locking tip 5 and a movably mounted sleeve 8 on the shaft 6 of the locking element 4, the locking tip 5 and at least portions of the shaft 6 being of radially resilient construction. Such a locking element 4 is particularly suitable for use with a resilient locking receptacle, since the spring travels that are necessary in making the snap connection are distributed to the resilient locking element and to the resilient locking receptacle, with the result that, in total, the snap connection requires a lesser overall height.

FIG. 22 shows a bottom view of a shaped tube 17 with housings 32 arranged therein. The figure shows that the housings 32 are movably mounted in the shaped tube 17 in the direction Q, transversely relative to the direction of insertion E of the locking element 4.

FIG. 23 shows the use of the device shown in FIG. 22 as a wardrobe rail, the figure showing that the clothes-hangers 19 connected to the locking element can be moved transversely relative to the direction of insertion E of the locking elements.

An embodiment in which a flexible profile rail 36 is used instead of the shaped tube is represented in FIG. 24. In this case, the flexible rail 36 is shown on a holding device 35 which, in the case of the embodiment shown, is realized as a furniture component.

1. Releasable snap connection between an elastically resilient part and a further part, said snap connection comprising both a locking element, which has a shaft and a locking tip, and a locking receptacle, the locking element engaging at least partially with the locking receptacle, characterized in that, for the purpose of releasing the snap connection, the locking element has a sleeve mounted movably along its shaft.

2. Snap connection according to claim 1, characterized in that, for the purpose of releasing the snap connection, the movable sleeve can be brought into a position which releases the resilient part in relation to a rigid part, and remains in this position until the locking element and the locking receptacle are disengaged.

3. Snap connection according to claim 2, characterized in that the resilient part of the snap connection is constituted by the locking receptacle, while the rigid part of the snap connection is constituted by the locking element.

4. Snap connection according to claim 2, characterized in that the resilient part of the snap connection is constituted by the locking element, while the rigid part of the snap connection is constituted by the locking receptacle.

5. Snap connection according to claim 1, characterized in that both parts constituting the snap connection are of elastically resilient construction.

6. Snap connection according to claim 5, characterized in that, for the purpose of releasing the snap connection, the movable sleeve can be brought into a position which releases the first resilient part in relation to the second resilient part, and remains in this position until the locking element and the locking receptacle are disengaged.

7. Snap connection according to claim 5, characterized in that the one resilient part is constituted by the locking element and the other resilient part is constituted by the locking receptacle.

8. Snap connection according to one of claims 1, characterized in that the locking receptacle has at least one resilient limb, which is shaped to encompass the locking tip of the locking element.

9. Snap connection according to claim 8, characterized in that the at least one resilient limb encompasses the locking tip of the locking element in a positive manner.

10. Snap connection according to claim 8, characterized in that the locking receptacle has at least two resilient limbs, whose free ends are shaped to engage between the locking tip and a flange-type enlargement on the shaft of the locking element.

11. Snap connection according to claim 10, characterized in that the at least two resilient limbs are substantially L-shaped.

12. Snap connection according to claim 8, characterized in that the locking receptacle is mounted in a housing having a passage aperture for the locking element, the resilient limb(s) bearing, by means of its (their) end(s) which encompasses (encompass) the locking tip of the locking element, on the housing.

13. Snap connection according to claim 1, characterized in that the locking receptacle has at least one springy element which is convex in relation to the locking element and which, when the connection has been made, engages at least with the shaft of the locking element.

14. Snap connection according to claim 13, characterized in that the locking receptacle has a plurality of convex springy elements, which constitute a funnel.

15. Snap connection according to claim 14, characterized in that the springy elements are tongue-shaped.

16. Snap connection according to claim 14, characterized in that the funnel is arranged in or is part of a housing.

17. Snap connection according to claim 16, characterized in that the housing is cylindrical.

18. Snap connection according to claim 1, characterized in that the locking receptacle is realized as a shaped tube and has at least one longitudinally extending passage aperture for the locking element(s), the wall of the tube having, on it least one side of the passage aperture, a plurality of gaps which extend substantially perpendicularly relative to the passage aperture and as far as the passage aperture.

19. Snap connection according to claim 18, characterized in that the shaped tube has a rectangular cross-sectional area.

20. Snap connection according to claim 1, characterized in that the locking element is mounted in a housing which has a passage aperture for the locking element, the housing is movable in a shaped tube having a longitudinally extending passage aperture.

21. Snap connection according to claim 1, characterized in that the shaft of the locking element has an enlargement, the sleeve being movably arranged on the shaft between this flange-type enlargement and the locking tip.

22. Snap connection according to claim 21, characterized by an annular, flange-type enlargement.

23. Snap connection according to claim 1, characterized in that the locking element has at least two locking segments, which are of radially resilient construction.

24. Snap connection according to claim 23, characterized in that at least one locking segment comprises a portion of the locking tip and a portion of the shaft of the locking element.

25. Snap connection according to claim 1, characterized in that the sleeve has at least two casing segments which are of radially resilient construction.

26. Snap connection according to claim 23 and 25, characterized in that the locking segments of the locking element and the casing segments of the sleeve are designed to engage with one another.

27. Snap connection according to claim 26, characterized in that the locking segments of the locking element and the casing segments of the sleeve are designed to engage with one another in a positive manner.

28. Snap connection according to claim 23 and 25, characterized in that the free ends of the locking segments of the locking element and/or the free ends of the casing segments of the sleeve are realized in the form of hooks.

29. Snap connection according to claim 1, characterized in that the sleeve is conically tapered on its side which faces the locking tip and/or the free end(s) of the limb(s) or the springy elements of the locking receptacle is (are) bevelled.

30. Snap connection according to claim 1, characterized in that the outer circumferential surface of the sleeve is designed for frictional engagement with the locking receptacle.

31. Snap connection according to claim 1, characterized in that the locking receptacle is constituted by a bore in a rigid part of the snap connection, for example in a wooden, metal or plastic panel or the like.

32. Snap connection according to claim 1, characterized in that the locking receptacle is realized as a shaped tube and has at least one bore and/or at least one longitudinally extending passage aperture for a resilient locking element.

33. Holding device comprising a snap connection, in particular according to claim 1, having at least one locking element and one locking receptacle, characterized in that the locking element is movably mounted in the holding device.

34. Snap connection according to claim 33, characterized in that the locking element is movable transversely relative to the direction of insertion E into the locking receptacle.

35. Holding device according to claim 33, characterized in that, when the snap connection has been made, the locking receptacle, together with the locking element, is mounted movably.

36. Snap connection according to claim 35, characterized in that when the snap connection has been made, the locking receptacle, together with the locking element, is mounted movably transversely relative to the direction of insertion E of the locking element.

37. Holding device according to claim 35, characterized in that the locking receptacle is arranged in a housing, wherein the housing is arranged on the holding device being movable in a guided manner.

38. Snap connection according to claim 37, characterized in that the housing is guided in a hollow profile or on a profile bar.

39. Holding device according to claim 35, characterized in that the locking receptacle is guided on a preferably flexible profile rail.
